(19) United States
(12) Patent Application Publication
(10) Pub. No.: US 2026/0161276 A1
(43) Pub. Date: Jun. 11, 2026

(54) USER INTERFACE AND FEEDBACK IMPROVEMENTS FOR VIRTUAL IMAGE CONFIGURATION

(71) Applicant: Tencent Technology (Shenzhen) company Limited, Shenzhen (CN)

(72) Inventor: Yan Wang, Shenzhen (CN)

(21) Appl. No.: 19/179,421

(22) Filed: Apr. 15, 2025

Related U.S. Application Data
(63) Continuation of application No. PCT/CN2024/077870, filed on Feb. 21, 2024.

(30) Foreign Application Priority Data
Apr. 11, 2023 (CN) 2023104160808

(51) Int. Cl. G06F 3/04845; G06F 3/04847; G06T 13/40; G06T 19/20

(52) U.S. Cl. CPC G06F 3/04845; G06F 3/04847; G06T 13/40; G06T 19/20; G06T 2200/24; G06T 2219/2004; G06T 2219/2021

(57) ABSTRACT

Aspects described herein provide for a method of virtual image configuration. Aspects herein provide for displaying a virtual image configuration interface including a virtual image of a virtual object and configuration option corresponding to image parameters, and each image parameter corresponding to a skeletal part in a skeletal model of the virtual object. Aspects herein provide for determining, based on a configuration operation, a target configuration option and target image parameter, determining a target skeletal part corresponding to the target configuration option, and adjusting location information of the target skeletal part in the skeletal model based on the configuration operation. Aspects further provide for updating and displaying the virtual image on the virtual image configuration interface based on the adjusted location information of the target skeletal part. Aspects further provide for updating and displaying animations based on the adjusted location information of the target skeletal part.

### CROSS-REFERENCE TO RELATED APPLICATIONS

This application is a continuation application of PCT Application PCT/CN 2024/077870, filed Feb. 21, 2024, which claims priority to Chinese Patent Application No. 2023104160808, filed on Apr. 11, 2023, each entitled “VIRTUAL IMAGE CONFIGURATION METHOD AND APPARATUS, DEVICE, AND STORAGE MEDIUM”, and each of which is incorporated herein by reference in its entirety.

### FIELD

Aspects provided herein related to the field of computer technologies, and in particular, to virtual image configuration methods and systems.

### BACKGROUND

Aspects described herein provide for customization of virtual images of virtual objects.

In a related technology, a developer pre-manufactures several virtual images (for example, pre-manufactures several human faces) by using a Blendshape technology. In a subsequent process, when a user customizes a virtual image, a vertex difference is made with reference to the pre-manufactured virtual images, to obtain a user-defined virtual image.

However, in the foregoing solution, to customize a virtual image with sufficient details, the developer needs to pre-manufacture a large quantity of virtual images, resulting in low efficiency of developing and maintaining an application program.

### SUMMARY

Aspects described herein provides a virtual image configuration method and apparatus, a device, and a storage medium. The technical solutions are as follows:

According to an aspects described herein, a virtual image configuration method is provided, performed by a computer device, and the method including:
displaying a virtual image configuration interface, the virtual image configuration interface including a virtual image of a virtual object and a configuration option respectively corresponding to at least one image parameter, and an image parameter that corresponds to each configuration option corresponding to a skeletal part in a skeletal model of the virtual object;
determining, in response to a configuration operation from the configuration option, a target configuration option indicated by the configuration operation, and obtaining a parameter value of a target image parameter corresponding to the target configuration option;
determining a target skeletal part corresponding to the target image parameter, adjusting a location of the target skeletal part in the skeletal model according to the parameter value of the target image parameter, and obtaining adjusted location information of the target skeletal part in the skeletal model; and
updating and displaying the virtual image on the virtual image configuration interface based on the adjusted location information of the target skeletal part in the skeletal model.

According to another aspect, a virtual image configuration apparatus is provided, the apparatus including:
an interface display module, configured to display a virtual image configuration interface, the virtual image configuration interface including a virtual image of a virtual object and a configuration option respectively corresponding to at least one image parameter, and an image parameter that corresponds to each configuration option corresponding to a skeletal part in a skeletal model of the virtual object;
a location obtaining module, configured to determine, in response to a configuration operation from the configuration option, a target configuration option indicated by the configuration operation, and obtain a parameter value of a target image parameter corresponding to the target configuration option; and determine a target skeletal part corresponding to the target image parameter, adjust a location of the target skeletal part in the skeletal model according to the parameter value of the target image parameter, and obtain adjusted location information of the target skeletal part in the skeletal model; and
an image updating module, configured to update and display the virtual image on the virtual image configuration interface based on the adjusted location information of the target skeletal part in the skeletal model.

According to another aspect, a computer device is provided, the computer device including a processor and a memory, the memory storing at least one instruction, at least one program, a code set, or an instruction set, and the at least one instruction, the at least one program, the code set, or the instruction set being loaded and executed by the processor to implement the virtual image configuration method according to the foregoing aspect.

According to another aspect, a computer-readable storage medium is provided, the readable storage medium having at least one instruction, at least one program, a code set, or an instruction set stored therein, and the at least one instruction, the at least one program, the code set, or the instruction set being loaded and executed by a processor to implement the virtual image configuration method according to the foregoing aspect.

According to another aspect, a computer program product is provided, the computer program product including computer instructions, the computer instructions being stored in a computer-readable storage medium, and a processor reading the computer instructions from the computer-readable storage medium and executing the computer instructions, to implement the virtual image configuration method according to the foregoing aspect.

Details of one or more aspects described herein are provided in the accompany drawings and descriptions below.

### BRIEF DESCRIPTION OF DRAWINGS

Aspects provided herein are described with reference to the accompanying drawings. The accompanying drawings are illustrative, and a person of ordinary skill in the art may derive other drawings from these accompanying drawings.

FIG. 1 is a structural block diagram of a computer system according to aspects described herein;

FIG. 2 is a flowchart of a virtual image configuration method according to aspects described herein;

FIG. 3 is a flowchart of a virtual image configuration method according to aspects described herein;

FIG. 4 is a flowchart of a virtual image configuration method according to aspects described herein;

FIG. 5 is a flowchart of a virtual image configuration method according to aspects described herein;

FIG. 6 is a schematic flowchart of an offline part of developing face sculpting logic according to aspects described herein;

FIG. 7 is a schematic flowchart of an online part of developing face sculpting logic according to aspects described herein;

FIG. 8 and FIG. 9 are diagrams of interfaces of importing and creating a skeleton Mesh file according to aspects described herein;

FIG. 10 is a diagram of an interface of face resource configuration according to aspects described herein;

FIG. 11 is a schematic diagram of a character image according to aspects described herein;

FIG. 12 is a schematic diagram of an interface according to aspects described herein;

FIG. 13 is a principle diagram of an animation blueprint according to aspects described herein;

FIG. 14 is a structural block diagram of a virtual image configuration apparatus according to aspects described herein; and

FIG. 15 is a structural block diagram of a computer device according to aspects described herein.

Accompanying drawings herein are incorporated into this specification.

### DETAILED DESCRIPTION

The following clearly and completely describes the technical solutions according to aspects described herein.

Aspects described herein are described in detail, and illustrative examples of the aspects are shown in the accompanying drawings. When the following descriptions involve the accompanying drawings, unless indicated otherwise, same numbers in different accompanying drawings represent same or similar elements. The implementations described in the following aspects do not represent all implementations

Terms used in the present disclosure are intended to describe aspects herein, but are not limiting. The singular forms “a/an”, “said”, and “the” used in the present disclosure and the appended claims are also intended to include plural forms, unless clearly specified otherwise in the context. The term “and/or” used herein refers to and includes any or all possible combinations of one or more associated listed items.

User information (including, but not limited to, user equipment information, user personal information, and the like) and data (including, but not limited to, data for analysis, stored data, displayed data, and the like) according to aspects described herein are all information and data that are authorized by a user or fully authorized by each party, and collection, use, and processing of relevant data need to comply with relevant laws, regulations, and standards of relevant countries and regions. For example, object behaviors such as an attack operation according to aspects described herein are all obtained with full authorization.

Although terms such as first and second may be used in the present disclosure to describe various information, the information is not limited to the terms. These terms are merely used to distinguish between information of the same type. For example, without departing from the scope of the present disclosure, a first parameter may also be referred to as a second parameter, and similarly, the second parameter may also be referred to as the first parameter. Depending on the context, for example, the word “if” used herein may be explained as “while” or “when” or “in response to determining”.

For ease of understanding, explanations of some terms according to aspects described herein are first described.

(1) Skeletal animation: The skeletal animation is one type of model animation, and an orientation and a location of a skeleton are changed to generate an animation for a model.

(2) Model: The model includes triangular faces. Such a triangular face is also referred to as a mesh, and there is a vertex on the mesh.

Correspondingly, in the skeletal animation, the mesh is also referred to as a skin. A connection position between skeletons is referred to as a joint, and the skeleton may rotate around the joint.

(3) Face sculpting: The face sculpting generally refers to a data operation of customizing (also referred to as do-it-yourself or “DIY”) an appearance of a virtual character in an online game.

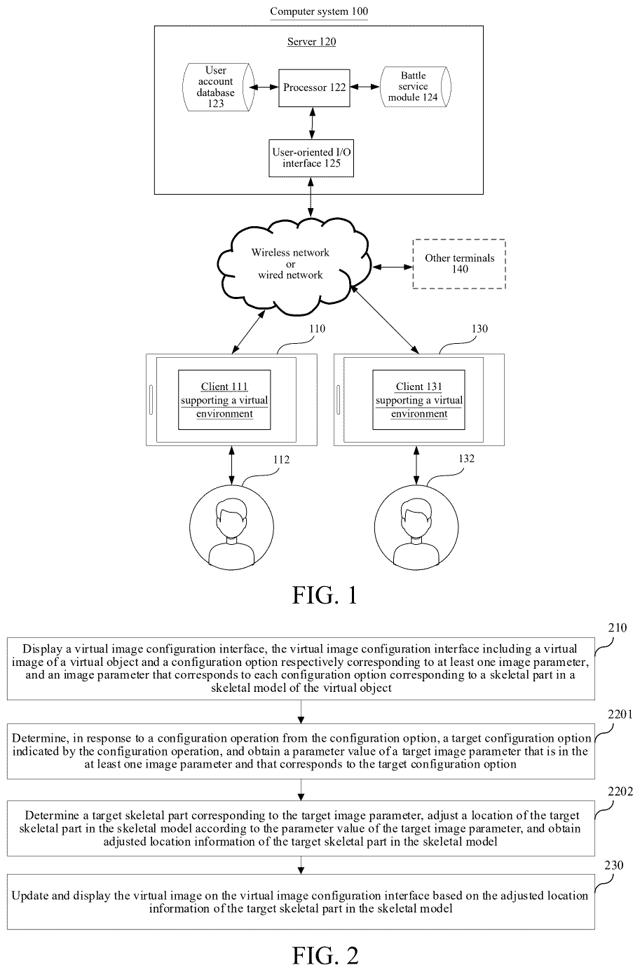

FIG. 1 is a structural block diagram of a computer system according to aspects described herein. The computer system 100 includes: a first terminal 110, a server 120, and a second terminal 130.

A client 111 supporting a virtual scene is installed and run on the first terminal 110, and the client 111 may be a multiplayer online battle program. When the first terminal 110 runs the client 111, a user interface of the client 111 is displayed on a screen of the first terminal 110. The client 111 may be any one of a simulation program, an arena shooting game, a virtual reality (VR) application program, an augmented reality (AR) program, a three-dimensional map program, a virtual reality game, an augmented reality game, a first-person shooting (FPS) game, a third-person shooting (TPS) game, a multiplayer online battle arena (MOBA), or a simulation game (SLG). In this aspect, an example in which the client 111 is the FPS game is used for description. The first terminal 110 is a terminal used by a first user 112. The first user 112 controls, by using the first terminal 110, a first virtual object located in the virtual scene to perform an activity. The first virtual object may be referred to as a virtual object of the first user 112. The activity of the first virtual object includes, but is not limited to, at least one of moving, jumping, teleporting, casting a skill, using a prop, adjusting a body pose, crawling, walking, running, riding, flying, jumping, driving, picking, shooting, attacking, or throwing. For example, the first virtual object is a first virtual character such as a simulated human character or an animated human character. A virtual object is an object that can perform activities in the virtual scene, may be an object that performs an activity under control of a user, may be an object that automatically performs an activity in the virtual scene according to a preset rule, or may be an object that performs an activity in the virtual scene in an artificial intelligence control manner.

A client 131 supporting the virtual scene is installed and run on the second terminal 130, and the client 131 may be a multiplayer online battle program. When the second terminal 130 runs the client 131, a user interface of the client 131 is displayed on a screen of the second terminal 130. The client may be any one of a simulation program, an arena shooting game, a VR application program, an AR program, a three-dimensional map program, a virtual reality game, an augmented reality game, an FPS, a TPS, an MOBA, or an SLG. In this aspect, an example in which the client is the MOBA game is used for description. The second terminal 130 is a terminal used by a second user 132. The second user 132 controls, by using the second terminal 130, a second virtual object located in the virtual scene to perform an activity. The second virtual object may be referred to as a virtual object of the second user 132. For example, the second virtual object is a second virtual character such as a simulated human character or an animated human character.

In some aspects, the first virtual object and the second virtual object are in the same virtual scene. In some aspects, the first virtual object and the second virtual object may belong to the same camp, the same team, or the same organization, have a friendship, or have temporary communication permission. In some aspects, the first virtual object and the second virtual object may belong to different camps, different teams, or different organizations, or have a hostile relationship with each other.

In some aspects, the client installed on the first terminal 110 is the same as the client installed on the second terminal 130, or the clients installed on the two terminals are the same type of clients of different operating system platforms (Android or IOS). The first terminal 110 may generally refer to one of a plurality of terminals, and the second terminal 130 may generally refer to another one of the plurality of terminals. In this aspect, only the first terminal 110 and the second terminal 130 are used as an example for description. The first terminal 110 and the second terminal 130 are of the same or different device types. The device type includes at least one of a smartphone, a tablet computer, an e-book reader, a moving picture experts group audio layer III (MP3) player, a moving picture experts group audio layer IV (MP4) player, a laptop portable computer, and a desktop computer.

FIG. 1 shows only two terminals. However, there are a plurality of other terminals 140 that can access the server 120 in different aspects. In some aspects, there are also one or more terminals 140 that correspond to a developer. A development and editing platform of a client supporting a virtual scene is installed on a terminal 140. A developer may edit and update the client on the terminal 140, and transmit an updated installation package to the server 120 via a wired or wireless network. The first terminal 110 and the second terminal 130 may download the installation package of the client from the server 120 to update the client.

The first terminal 110, the second terminal 130, and the another terminal 140 are connected to the server 120 via a wireless network or a wired network.

The server 120 includes at least one of one server, a plurality of servers, a cloud computing platform, and a virtualization center. The server 120 is configured to provide a backend service for a client supporting a three-dimensional virtual scene. In some aspects, the server 120 takes primary computing work, and the terminal takes secondary computing work. Alternatively, the server 120 takes secondary computing work, and the terminal takes primary computing work. Alternatively, a distributed computing architecture is used between the server 120 and the terminal to perform collaborative computing.

For example, the server 120 includes a processor 122, a user account database 123, a battle service module 124, and a user-oriented input/output Interface (I/O interface) 125. The processor 122 is configured to load instructions stored in the server 120, and process data in the user account database 123 and the battle service module 124. The user account database 123 is configured to store data of user accounts used by the first terminal 110, the second terminal 130, and the another terminal 140, such as avatars of the user accounts, nicknames of the user accounts, fighting power indexes of the user accounts, and service areas of the user accounts. The battle service module 124 is configured to provide a plurality of battle rooms for users to battle, for example, a 1V1 battle room, a 3V3 battle room, a 5V5 battle room, and the like. The user-oriented I/O interface 125 is configured to establish communication between the first terminal 110 and/or the second terminal 130 via a wireless network or a wired network for data exchange.

Aspects provided herein may be applied to, but is not limited to, at least one of the following scenarios: an application program that allows a user to customize a virtual image of a virtual object, such as a VR application program, a simulation program, a first-person shooting (FPS) game, a third-person shooting (TPS) game, or a multiplayer firearm survival game. Aspects are described using an application in a game as an example, but other applications may be possible.

FIG. 2 is a flowchart of a virtual image configuration method according to aspects described herein. The method may be performed by a computer device. The method includes the following operations.

Operation 210: Display a virtual image configuration interface, the virtual image configuration interface including a virtual image of a virtual object and a configuration option corresponding to an image parameter, wherein an image parameter corresponds to a skeletal part in a skeletal model of the virtual object.

The virtual image is a visual effect presented by the virtual object in a virtual scene. According to an aspect, the image parameter may be a parameter corresponding to each shape-adjustable appearance image portion in the virtual image. For example, image parameter may include an eyebrow height, an eyebrow width, a nose height, a nose width, an eye height, an eye width, an eye size, and the like.

The image parameters are merely used as examples for illustration. A developer may set types of the image parameters according to a requirement for a product. For example, the eyebrow height may be further refined into a height of an eyebrow edge and a height of a middle portion of an eyebrow; and the nose height may be further refined into a height of a nose tip, a height of a nose bridge, and the like. The types of the image parameters are not limiting.

In a skinned animation, a skeleton is constructed by using a rigid “bone”. The rigid component (namely, the skeleton, also referred to as a “joint” in some scenarios) is not rendered and displayed, and is always hidden. A round triangular mesh referred as to a skin is bound to the skeleton, and a vertex of the mesh follows movement of the joint. Each vertex on the skin may be bound to one or more skeletons according to a weight. Therefore, when a location of the skeleton changes, the skin may naturally stretch. A model of skeletons forming the virtual object is the skeletal model (where the skeletal model is different from an object model of the virtual object, and the object model is a model obtained by performing skinning processing on the skeletal model). In this aspect, each image parameter may correspond to one or more vertexes on the skin, and a skeleton to which the one or more vertexes corresponding to the image parameter are bound is a skeletal part corresponding to the image parameter. Skinning processing refers to processing of binding a skin to a skeleton.

For example, the skeletal model is stored in a form of skeleton matrix data. For example, the skeleton matrix data comprises a skeleton and a pose, which are respectively described below.

1. The skeleton includes joints and may be a tree structure. The skeleton is stored in an internal memory in a form of an array. A structure of data related to the skeleton may be shown as follows.

(1) A data structure (struct Joint) of a joint includes: a joint name (const char* m_name), a parent node index (U8m_iParent) of the joint, and an inverse matrix (Matrix4×3 m_invBindPose) of a corresponding binding pose when a skinned mesh vertex is bound to the joint.

(2) A data structure (struct Skeleton) of a skeleton includes: joint data (U32 m_jointCount) included in the skeleton, and a data structure array (Joint* m_aJoint) of each joint included in the skeleton.

2. The pose describes a relative pose location, and a T-pose is usually used as a binding pose (namely, an initial pose form, which may alternatively be understood as an initial pose space). Joints are randomly rotated, translated, and scaled, so that the skeleton can be shown in various poses. A pose of a joint is defined as a location, an orientation, and scaling of the joint relative to a frame of reference. The pose of the joint is usually represented by using a 4×4 matrix or a 4×3 matrix, or represented as an SQT data structure. The SQT data structure is used as an example, and a structure of data related to the pose may be shown as follows.

(1) Local pose: The local pose is a pose location of a child node relative to a parent node, and is stored in an SQT format (scaling, quaternion, or translation). It is generally considered that synchronous scaling is performed.

A data structure (struct JointPose) of a local joint pose may include: a quaternion (Quaternion m_rot), translation (Vector3 m_trans), and uniform scaling (F32 m_scale). Alternatively, another data structure (struct JointPose) of the local joint pose may include: a quaternion, translation (Vector4 m_trans), and non-uniform scaling (Vector4 m_scale).

A data structure (struct SkeletonPose) of a local skeleton pose may include: a quantity of skeletons and joints (Skeleton* m_pSkeleton) and a plurality of local joint poses (JointPose* m_aLocalPose). A size of an array of local joint poses keeps consistent with a quantity of joints.

(2) Global pose: Because an SQT matrix of each child node is relative to a parent node space, to convert the SQT matrix of the child node into a model space or a world space matrix, recursive calculation needs to be performed layer by layer to a root node.

For example, when a child node at a j^{th} layer recurses to the root node (where p(j) is defined to represent a parent node of the j node), a formula P(j->M)=P(j->p(j))*P(p(j)->p(p(j))) . . . is obtained.

A data structure (struct SkeletonPose) of a global skeleton pose may include: a quantity of skeletons and joints (Skeleton* m_pSkeleton), a plurality of local joint poses (JointPose*m_aLocalPose), and a plurality of global joint poses (Matrix44*m_aGlobalPose).

A configuration option is configured for configuring a parameter value of an image parameter corresponding to the configuration option. The image parameter may correspond to one configuration option. In other aspects, the image parameter may alternatively correspond to a plurality of configuration options. The configuration option may provide a function of performing adjustment within a value range of the image parameter. In this aspect, one skeletal part may include one or more skeletons (or joints) on which location transformation (including coordinate transformation, direction transformation, or the like) may be performed in the skeletal model of the virtual object (or one skeletal part includes one or more joints), and each skeletal part may correspond to the image parameter. On the virtual image configuration interface, one configuration option may be set corresponding to each image parameter.

A change of a skeletal part affects an appearance of the virtual object by using an associated vertex, and an objective of adjusting the virtual image of the virtual object by a user is also to change the appearance of the virtual object. Based on this, this aspect provides a solution of associating an image parameter of a virtual image with a skeletal part of a virtual object, a skeleton/joint of a skeletal model of the virtual object is extended, a skeleton/joint that may affect the virtual image (for example, a face image) of the virtual object is set, and a corresponding configuration option is set.

Specifically, the developer may develop a skeletal part (including one or more joint points) in the skeletal model of the virtual object according to an adjustable image parameter (for example, an eyebrow height, an eye width, or a nose height). For example, corresponding to the image parameter of the eyebrow height, one or more joint points corresponding to an eyebrow may be added to the skeletal model of the virtual object, corresponding to the image parameter of the eye width, one or more joint points corresponding to an eye corner may be added to the skeletal model of the virtual object, and corresponding to the image parameter of the nose height, one or more joint points corresponding to a nose may be added to the skeletal model of the virtual object. In addition, the developer further sets corresponding configuration options for the joint points related to the eyebrow, the eye corner, the nose, and the like.

The configuration option may be an option in a form of a drag bar, or may be an option in a form of a selection box, an input box, or the like. An implementation form of the configuration option is not limiting.

Operation 2201: Determine, in response to a configuration operation from the configuration option, a target configuration option indicated by the configuration operation. Obtain a parameter value of a target image parameter that is in the image parameter and that corresponds to the target configuration option.

Operation 2202: Determine a target skeletal part corresponding to the target image parameter, adjust a location of the target skeletal part in the skeletal model according to the parameter value of the target image parameter, and obtain adjusted location information of the target skeletal part in the skeletal model.

The target configuration option is a configuration option corresponding to the image parameter. One or more configuration options may correspond to an image parameter, and vice versa. The target image parameter is the image parameter corresponding to the configuration operation. An image parameter represents a dimension of the virtual image, and a parameter value of the image parameter is a quantization in the dimension. The target skeletal part is a skeletal part corresponding to the target image parameter corresponding to the target configuration option. When receiving the configuration operation, the computer device may obtain the parameter value, for example, the eyebrow height or the nose width, of the target image parameter corresponding to the target configuration option after the configuration operation is performed.

In this aspect, the user may perform, on the virtual image configuration interface, the configuration operation on a configuration option corresponding to an image parameter. For example, when the configuration option may be an option in a form of a drag bar, the user may drag a block/dotted control in the drag bar, to modify a parameter value of the image parameter. In another example, when the configuration option is an option in a form of a selection box, the user may click/tap the option to pop up a drop-down selection box. The drop-down selection box includes one or more parameter options. One parameter option is selected from the drop-down selection box, and the parameter value of the image parameter is set to a parameter value corresponding to the selected parameter option.

After receiving the configuration operation, the computer device determines, according to a result of the configuration operation, adjusted location information of a skeletal part in the skeletal model and which corresponds to the image parameter. A configuration option may indicate different parameter values, which may correspond to different location information of a skeletal part in the skeletal model.

Operation 230: Update and display the virtual image on the virtual image configuration interface based on the adjusted location information of the target skeletal part in the skeletal model.

In this aspect, after the location of the target skeletal part in the skeletal model changes, the computer device may generate an updated virtual image according to a changed skeletal model, and display the updated virtual image on the virtual image configuration interface.

For example, the computer device may generate the updated virtual image through a game engine (such as a UE4 engine) and according to the changed skeletal model.

Additionally or alternatively, updating and displaying the virtual image on the virtual image configuration interface based on the adjusted location information of the target skeletal part in the skeletal model may include:
performing skin deformation processing on the skeletal model based on the adjusted location information of the target skeletal part in the skeletal model, to obtain an updated virtual image; and
displaying the updated virtual image on the virtual image configuration interface.

In this aspect, the computer device may perform skin deformation processing on the skeletal model by using a skin deformation technology and based on the adjusted location information of the target skeletal part in the skeletal model, to obtain the updated virtual image.

Skin deformation processing is processing in which a skin of an object model is deformed under a constraint of a skeleton in the skeletal model. When a structure of the skeleton in the skeletal model changes, the skin also changes based on a binding relationship between the skin of the object model and the skeleton in the skeletal model. Deforming the skin based on the skeletal may be preferred compared to directly deforming the virtual image because the skin deformation processing avoids distortion caused by local deformation of the virtual image.

In this aspect, after the location of the target skeletal part in the skeletal model changes, a location of a vertex that is bound to the target skeletal part and that is in the object model of the virtual object changes correspondingly. This is the skin deformation processing.

The object model may be updated through the skin deformation processing and with reference to the change of the location of the vertex. For example, the virtual image displayed on the virtual image configuration interface is updated corresponding to the configuration operation.

Skin deformation processing may be performed on the adjusted skeletal model, so that the virtual image may be updated. This avoid developing a different virtual image for each image parameter, thereby greatly reducing workload in a development process, and improving efficiency of developing and updating an application program.

According to an aspect, the computer device may further store image data of the virtual object, the image data including skeleton matrix data of the updated skeletal model.

In this aspect, after the user completes configuration on the virtual image of the virtual object in a customized manner, the computer device may store image data corresponding to the virtual object, so as to subsequently display, outside the virtual image configuration interface, the virtual image of the virtual object configured by the user. The image data may include skeleton matrix data that is of an updated skeletal model and that is configured by the user.

For example, the image data may include skeleton matrix data corresponding to an updated complete skeletal model of the virtual object.

The computer device may store a piece of complete skeleton matrix data of the virtual object, wherein the skeleton matrix data including matrix data of all skeletons/joints of the virtual object. The skeleton matrix data is matrix data based on the initial matrix data of the virtual object and modified based on a configuration operation of the user.

The initial skeleton matrix data may include initial matrix data of all the skeletons/joints of the virtual object, namely, matrix data of all the skeletons/joints of the virtual object in an initial pose and an initial body shape. The initial skeleton matrix data may include skeletal parts corresponding to all image parameters, and may further include a skeleton/joint other than the skeletal parts corresponding to the image parameters. For example, in addition to including skeletal parts corresponding to various image parameters (for example, skeletal parts corresponding to facial features and hair of the virtual object), the skeletal model of the virtual object may further include another skeletal part (for example, a hand skeleton/joint or a knee skeleton/joint of the virtual object) configured for controlling a pose of the virtual object.

The skeletal model of the virtual object may include another skeletal part configured for controlling the pose of the virtual object. When subsequently generating and controlling the virtual object in the virtual scene, the computer device may generate the virtual object by reusing the complete skeleton matrix data of the virtual object and control the virtual object to perform an action corresponding to the pose of the virtual object. This may avoid reconstructing updated skeleton matrix data of the virtual object, thereby improving processing efficiency and reducing computing requirements when the virtual object is subsequently generated and controlled in the virtual scene.

Additionally or alternatively, the image data may include skeleton matrix data corresponding to a changed skeleton part compared to the initial skeleton matrix data of the virtual object.

In this example, the computer device may store only difference data between an updated complete skeletal model of the virtual object and an initial skeletal model of the virtual object. The difference data is combined with the initial skeleton matrix data to obtain the updated complete skeleton matrix data of the virtual object. The initial skeleton matrix data may be shared by a plurality of virtual objects. Therefore, a system needs to store only one set of initial skeleton matrix data, then difference data of each virtual object, and can generate an updated model of each virtual object while greatly reducing storage resources.

The following aspect will be described in the context of a face sculpting scenario in a game. Each virtual object belonging to the same group and the same gender uses the same initial skeleton matrix data. The initial skeleton matrix data may be stored in a server end. A user corresponding to each virtual object may load the initial skeleton matrix data on a terminal of the user, and perform DIY on an image parameter of the virtual object of the user by using the foregoing configuration control. After configuration is completed, each terminal/game server needs to store only difference data of each virtual object, rather than storing complete skeleton matrix data for each virtual object.

In conclusion, in this aspect, the image parameter of a virtual image displayed on a virtual image configuration interface respectively corresponds to a configuration option, and an image parameter corresponding to each configuration option corresponds to a skeletal part in a skeletal model of a virtual object. When a configuration operation is received, adjusted location information of a target skeletal part that corresponds to the target configuration option and that is in the skeletal model is obtained, and the virtual image is updated and displayed based on the adjusted location information of the target skeletal part in the skeletal model. After the configuration operation is performed by the user on the image parameter of the virtual image, a location of the corresponding skeletal part in the skeletal model that corresponds to the virtual image is directly adjusted, that is, the virtual image can be configured in a customized manner, and a large quantity of virtual images do not need to be prepared in advance. This can greatly reduce workload in application development process (for example, game development), so as to improve efficiency of application development and updating.

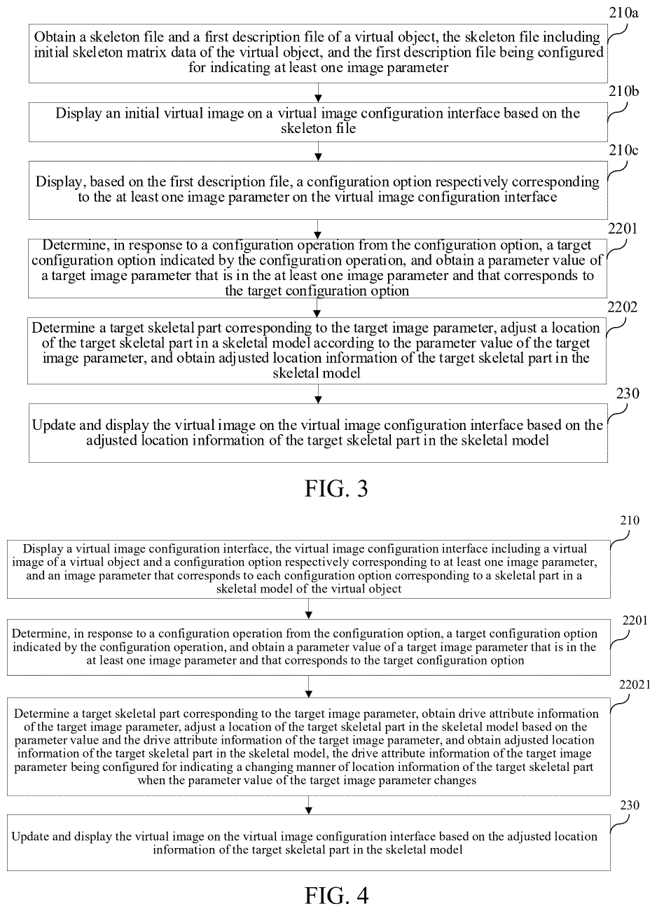

FIG. 3 is a flowchart of a virtual image configuration method according to aspects described herein. The method may be performed by a computer device. Operation 210 in FIG. 2 may be implemented as operation 210a, operation 210b, and operation 210c.

Operation 210a: Obtain a skeleton file and a first description file of the virtual object, the skeleton file including initial skeleton matrix data of the virtual object, and the first description file being configured for indicating the image parameter.

In this aspect, a developer may pre-develop and configure a corresponding skeleton file and a corresponding first description file for each virtual object. The skeleton file stores initial skeleton matrix data corresponding to the virtual object.

In a game engine, a skeleton is usually represented by using a matrix, namely, a skeleton matrix. Each skeleton may have one or more matrices, configured for controlling transformation of vertexes related to the matrices.

The skeleton file and the first description file each may be a file that can be parsed and processed by the game engine. A UE4 engine is used as an example, the skeleton file may be an engine file (for example, an .fbx file) of a virtual engine, and the first description file may be a JSON file.

Operation 210b: Display an initial virtual image on the virtual image configuration interface based on the skeleton file.

In this aspect, the computer device may generate, based on the initial skeleton matrix data in the skeleton file, the initial virtual image of the virtual object through the game engine and by using a skinning technology.

Operation 210c: Display, based on the first description file, the configuration option respectively corresponding to the image parameter on the virtual image configuration interface.

In this aspect, the computer device may separately display, through the game engine and based on the image parameter indicated by the first description file, a configuration option corresponding to each image parameter on the virtual image configuration interface, to implement visual configuration on the virtual image by the user.

For example, different parts of the virtual image of the virtual object may be displayed on the virtual image configuration interface according to a location of the virtual image that is currently adjusted by the user.

Additionally or alternatively, a part selection control may be displayed on the virtual image configuration interface. After the user clicks/taps the part selection control, a part selection box may pop up, and the part selection box includes one or more part options: for example, a head, an upper body, and a whole body. Different part options correspond to different body parts of the virtual image and adjustable image parameters. For example, when the user selects a part option of the head, an image of the head of the virtual object and a configuration option (for example, a configuration option such as an eye, a nose, or an eyebrow) corresponding to the head may be displayed on the virtual image configuration interface. When the user selects a part option of the upper body, an image of the upper body of the virtual object and a configuration option (for example, a configuration option such as a chest circumference or a wingspan) of a chest may be displayed on the virtual image configuration interface. When the user selects a part option of the whole body, an image of the whole body of the virtual object and a configuration option (for example, a configuration option such as a leg length or a waist circumference) of a lower body may be displayed on the virtual image configuration interface.

In this aspect, a virtual image and a configuration option corresponding to an adjustable image parameter of the virtual image are separately displayed on the virtual image configuration interface by using a skeleton file and a first description file. When the image parameter is subsequently adjusted through a configuration option, location information of a skeletal part may be adjusted based on initial skeleton matrix data, to obtain a new virtual image, and different virtual images do not need to be developed for each image parameter, thereby greatly reducing workload in a development process, and improving efficiency of application program development and updating.

For example, the first description file includes an identifier of the image parameter and an adjustment range of the image parameter.

Displaying, based on the first description file, the configuration option corresponding to the image parameter on the virtual image configuration interface may include:
displaying an option name of a first configuration option on the virtual image configuration interface based on an identifier of a first image parameter, the first image parameter being any one of the image parameter, and the first configuration option being a configuration option corresponding to the first image parameter; and
displaying an option control of the first configuration option on the virtual image configuration interface based on an adjustment range of the first image parameter.

In this aspect, for each adjustable image parameter, an identifier and an adjustment range that correspond to the image parameter may be stored in the first description file. With the identifier and the adjustment range of the image parameter, the computer device may display a name and an option control of the corresponding image parameter on the virtual image configuration interface, facilitating user interaction when performing a configuration operation.

The first description file may describe the adjustable image parameters, an initial value of each image parameter, and an adjustable range of each image parameter. The computer device may automatically generate a configuration option corresponding to each image parameter by using the first description file, and may modify the configuration option on the virtual image configuration interface by changing the image parameter in the first description file, to greatly improve flexibility of developing/updating the configuration option on the virtual image configuration interface.

FIG. 4 is a flowchart of a virtual image configuration method according to aspects described herein. FIG. 4 may be further based on the aspects described with respect to FIG. 2 or FIG. 3. The method may be performed by a computer device. Operation 2202 in FIG. 3 may also be implemented as operation 22021 in FIG. 4: determining the target skeletal part corresponding to the target image parameter, obtaining drive attribute information of the target image parameter, adjusting the location of the target skeletal part in the skeletal model based on the parameter value and the drive attribute information of the target image parameter, and obtaining the adjusted location information of the target skeletal part in the skeletal model, the drive attribute information of the target image parameter being configured for indicating a changing manner of the location information of the target skeletal part when the parameter value of the target image parameter changes.

The drive attribute information of the target image parameter is configured for indicating the changing manner of the location information of the target skeletal part when the parameter value of the target image parameter changes.

In this aspect, wherein a game engine in the computer device obtains the drive attribute information of the target image parameter, the game engine may determine the changing manner of the location information of the target skeletal part. Based on this, the adjusted location information of the target skeletal part in the skeletal model may be determined based on the parameter value of the target image parameter corresponding to the target configuration option. This allows the user can directly modify skeleton matrix data of the virtual object through a configuration operation on a configuration option on the interface, ensuring that the user can customize and modify the skeleton matrix data of the virtual object.

For example, the drive attribute information of the target image parameter includes:
a mapping relationship between the parameter value of the target image parameter and the location information of the target skeletal part.

In this aspect, the mapping relationship between the parameter value of the target image parameter and the location information of the target skeletal part may be a formula for calculating the location information of the target skeletal part by using the parameter value of the target image parameter.

Additionally or alternatively, the mapping relationship between the parameter value of the target image parameter and the location information of the target skeletal part may be a mapping table between the parameter value of the target image parameter and the location information of the target skeletal part.

For example, each image parameter corresponds to drive attribute information, and the drive attribute information is configured for indicating a relationship between a parameter value of the image parameter and location information of a corresponding skeletal part. In this way, the user may modify a parameter value indicated by a corresponding configuration option, to accurately modify skeleton matrix data corresponding to the image parameter on the backend, thereby reducing complexity of modifying the skeleton matrix data by the user, and improving operation efficiency of customizing a virtual image by the user.

In another example, the virtual image configuration method further includes: obtaining a second description file of the virtual object, the second description file including drive attribute information of the image parameter.

In this aspect, drive attribute information of each image parameter of the virtual object may be preset by the developer in the second description file corresponding to the virtual object. When displaying the virtual image configuration interface, the computer device may load the second description file through the game engine to obtain the drive attribute information of each image parameter of the virtual object. The developer may only need to preset a description file configured for describing drive attribute information of an image parameter. The computer device may load the description file and automatically complete modification of skeleton matrix data of the virtual object according to a configuration operation of the user. When an adjustment effect of an image parameter needs to be modified, the developer need only modify drive attribute information in the description file. When a new adjustable image parameter needs to be added, only corresponding drive attribute information needs to be added to the description file, thereby greatly improving the developer's efficiency.

The second description file and the first description file may be the same description file. Alternatively, the second description file and the first description file may be different description files.

According to an aspect, obtaining the adjusted location information of the target skeletal part in the skeletal model based on the parameter value of the target image parameter and the drive attribute information of the target image parameter may include: obtaining, through a plug-in based on an animation blueprint, the adjusted location information of the target skeletal part in the skeletal model based on the parameter value of the target image parameter and the drive attribute information of the target image parameter.

In this aspect, the plug-in based on an animation blueprint may be set in an application program. Logic of obtaining the adjusted location information of the target skeletal part in the skeletal model based on the parameter value of the target image parameter and the drive attribute information of the target image parameter is implemented through the plug-in.

The animation blueprint is a visual script, and may be configured for creating and controlling a complex animation behavior.

The animation blueprint is a dedicated blueprint, and is configured for controlling an animation of a framework mesh. The computer device may edit an animation blueprint chart in an animation blueprint editor, to perform animation mixture, for example, directly control a skeleton of a framework, or set logic of finally defining a final animation pose of a framework mesh to be used for each frame.

In this aspect, the computer device may automatically modify the skeleton matrix data of the virtual object for the configuration operation of the user through the plug-in based on an animation blueprint, so that an operation process of automatically modifying the skeleton matrix data of the virtual object through the configuration operation of the user can be implemented, thereby simplifying operations of the user, and improving human-computer interaction efficiency in the process of modifying the skeleton matrix data.

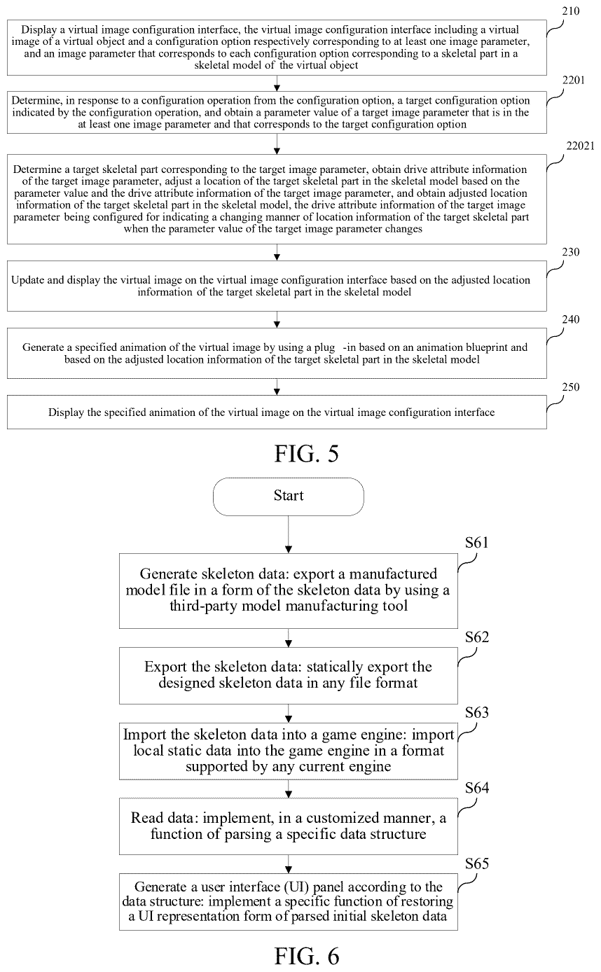

FIG. 5 is a flowchart of a virtual image configuration method according to aspects described herein. The method illustrated in FIG. 5 may be further based on the method illustrated in FIGS. 2 and 4.

Operation 240: Generate a specified animation of the virtual image by using the animation blueprint and based on the adjusted location information of the target skeletal part in the skeletal model.

In this aspect, after and/or while updating and displaying the virtual image, the computer device may further generate the specified animation based on the animation blueprint and based on the adjusted location information of the target skeletal part in the skeletal model, to reflect an action effect of an updated virtual image.

Operation 250: Display the specified animation of the virtual image on the virtual image configuration interface.

After generating the specified animation, the computer device may display the specified animation of the virtual image on the virtual image configuration interface (i.e., to the user).

In a skeletal animation, a virtual engine may drive an action of the virtual object by using skeleton data. After the user directly modifies, based on a configuration control, skeleton matrix data corresponding to the virtual image of the virtual object, the computer device may directly generate, according to modified skeleton matrix data (where the location information of the target skeleton part is adjusted location information), an animation effect of the virtual object after the skeleton matrix data is modified, so that the user can more intuitively see a modification effect of the virtual image through the animation, and the user determines, through the animation effect, whether to continue to adjust the virtual image, thereby improving interaction efficiency of customizing the virtual image by the user.

For example, the specified animation is a partial animation corresponding to the target skeletal part.

For example, each time the user configures an image parameter, the computer device may generate, based on the configured image parameter and by using an animation blueprint, an action effect corresponding to the image parameter. For example, after the user configures a location of an eyebrow, the computer device may generate, based on the animation blueprint, a specified animation of raising the eyebrow and present the specified animation to the user. Presenting an animation effect based on the modified corresponding image parameter improves the configuration operation for the user because the user can quickly see an effect of the customization.

Additionally or alternatively, the specified animation is a whole animation corresponding to the skeletal model.

For example, each time the user configures an image parameter, the computer device may generate, based on the animation blueprint after the image parameter is configured, an entire action effect corresponding to the image parameter and present the action effect to the user. For example, a running action, a skill action, and the like after the image parameter is configured are presented to the user, thereby reflecting an impact on the whole virtual image of the virtual object after the user customizes one or more virtual images of the virtual object.

Aspects described herein may be applied to other scenarios wherein a virtual image of a virtual object is configured in a customized manner. For example, scenarios such as face sculpting and figure adjustment (adjustment of parameters such as a height and a body shape). Specifically, in a game scenario, based on aspects described herein, the following interaction effects can be achieved:
(1) a player is allowed to design a face effect of the player in a customized manner;
(2) a slide bar of a player is supported as an operation and a visual operation;
(3) the player may store customized face sculpting data online;
(4) the player may save and reset the face sculpting data at any time;
(5) the player may customize a plurality of attributes and/or customize sculptable areas;
(6) the player may view playback performance of an expression animation while face sculpting.

Development and application processes of a face sculpting function in a game are used as an example. In this solution, face sculpting data based on a face skeleton is first generated by art staff by using a development tool, and the face sculpting data is exported and is imported into an engine in a JSON form. During loading and running of a face sculpting interface, a technical side dynamically adds and reads JSON data, parses the data, and initializes a value range for face sculpting. After the player performs a face sculpting operation, data obtained after the player sculpts a face is saved, and a location of a skeleton for the face sculpting is updated by using an animation thread. In addition, animation nodes need to be separately updated to update a large amount of skeleton information.

Aspects herein may be implemented as follows:

### I. Offline Part

FIG. 6 is a schematic flowchart of an offline part of developing face sculpting logic according to aspects described herein.

S61: Generate skeleton data: export a manufactured model file in a form of skeleton data by using any third-party model manufacturing tool. A main objective herein is to obtain initial skeleton matrix data in the model file.

S62: Export the skeleton data: statically export the designed skeleton data in any file format, where the data includes only the initial skeleton matrix data.

S63: Import the skeleton data into a game engine: import local static data into the game engine in a format supported by any current engine. A main objective herein is to provide the data to the game engine for use, and the essence of the solution is to modify the initial skeleton matrix data of a face.

S64: Read data: implement, in a customized manner, a function of parsing a specific data structure. A main objective is to parse a current data format for use in a subsequent process.

S65: Generate a user interface (UI) panel according to the data structure: implement a specific function of restoring a UI representation form of the parsed initial skeleton matrix data. For example, the skeleton data includes skull coordinates and needs to be presented to a player in a form of a UI, for the player to perform an operation on the UI.

The player performs an operation to modify the initial skeleton matrix data in a form of the UI panel, which may be a slide bar or an edit box. The manner is not limited. Essentially, the player modifies the underlying initial skeleton matrix data, refreshment and recalculation are performed on the skeleton data modified by the player, and a value is assigned to new skeleton data for representation.

### II. Online Part

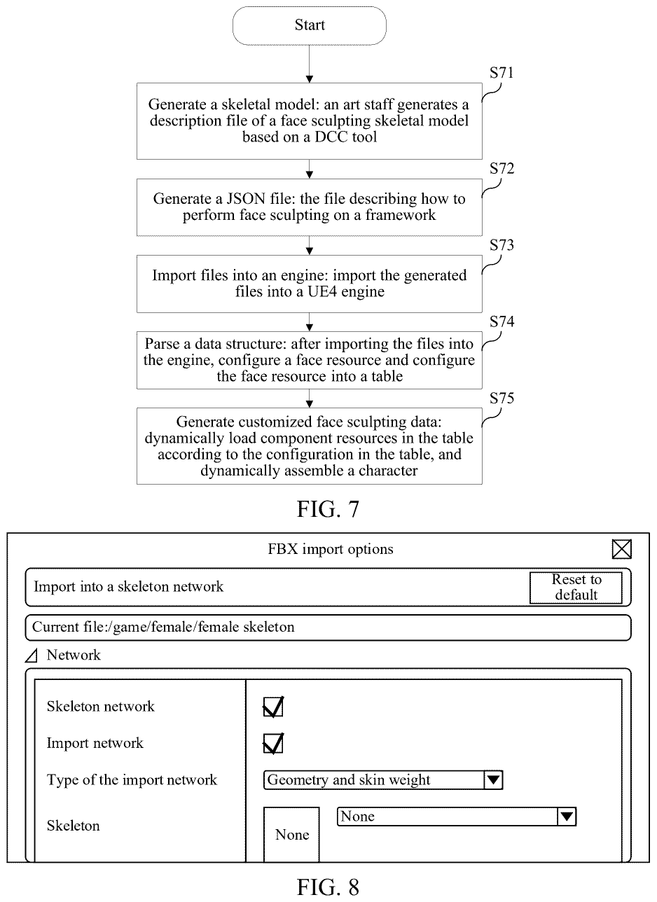

FIG. 7 is a schematic flowchart of an online part of developing face sculpting logic according to aspects described herein. An example in which the face sculpting logic is implemented through the UE4 engine is used. As shown in FIG. 7, the process may be as follows:

S71: Generate a skeletal model: An art staff generates a description file of a face sculpting skeletal model based on a development tool. A tool plug-in needs to be provided for an art designer herein. One skeleton file and one JSON file are provided.

S72: Generate the JSON file: the JSON file describing how to perform face sculpting on a framework, and the following information is included:
(A) a quantity of adjustable parameters, for example, an “eyebrow spacing” and a “nose tip height”;
(B) adjustable ranges of these parameters, for example, the “eyebrow spacing” ranges from 0 to 100, with a default value of 50; and
(C) a manner of modifying the skeleton parameters when the parameters change, so that a mesh changes correspondingly. For example, when the “eyebrow spacing” is 0, a skeleton of the eyebrow is to be increased by Transform (10, 0, 0) and is to be rotated by (0, 30, 0) relative to an original location. The skeleton name and the values herein are examples.

Code for the JSON file may be as follows:

```
{
  “Name”: “Middle_r_up”, // a modified part
  “DefaultValue”: 50.0, // an initial default value
  “MaxValue”: 100.0, // a maximum value
  “MinValue”: 0.0, // a minimum value
  “Driven attributes”: {
    “Game_RightMiddleEyebrow.translateX”: [ // a modified current value
      [
        0.0,
        −0.542,
      ],
      [
        50.0,
        0.0,
      ],
      [
        100.0,
        0.8,
      ],
    ]
  }
  “GroupName”: “meimao” // a current group name
  “GroupTitle”: “meimao” // a current title name
}
```

S73: Import files into an engine: import the generated JSON file and a skeleton Mesh file into the UE4 engine, where the JSON file includes information for describing how to perform face sculpting on the framework.

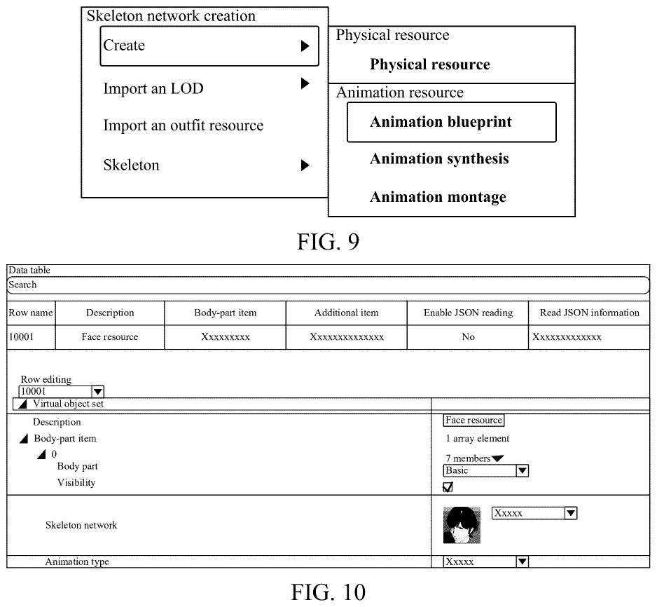

FIG. 8 and FIG. 9 are diagrams of interfaces of importing and creating a skeleton Mesh file according to aspects described herein.

S74: Parse a data structure: after importing the files into the engine, first configure a face resource and configure the face resource into a table, so as to load the resource in a subsequent process.

FIG. 10 is a diagram of an interface of face resource configuration according to aspects described herein.

The face resource may be a face model resource, an animation state machine resource corresponding to the face model resource, or the like.

S75: Generate customized face sculpting data: During running, a system dynamically loads component resources in the table according to the configuration in the table, and then dynamically assembles a character after resource loading is called back. An assembled character is a complete character.

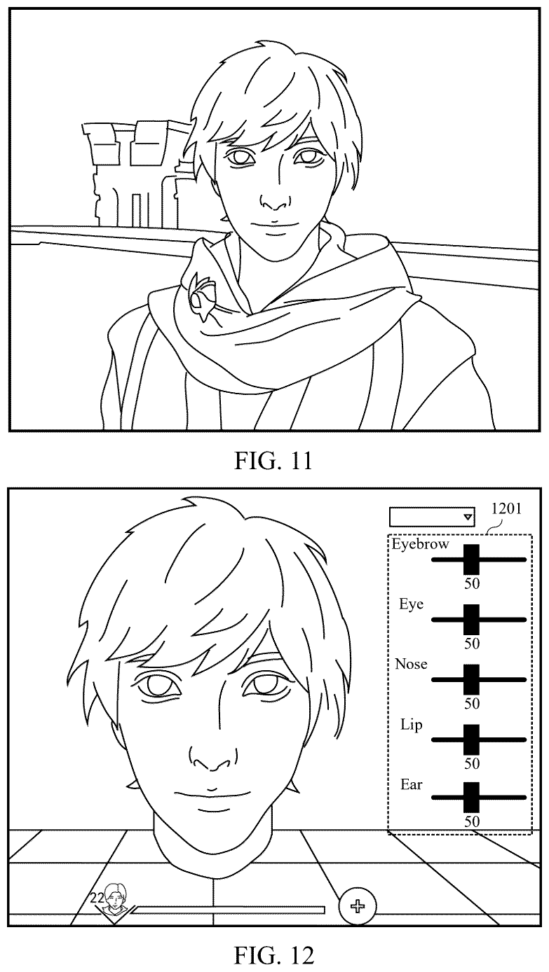

FIG. 11 is a schematic diagram of a character image according to aspects described herein.

A UI panel for a player to perform a UI face sculpting operation is built according to a UI requirement at a UI design side. During running, an underlying framework dynamically fills UI information with parsed data. For example, a name of a sculptable part and a sculptable data range are obtained through parsing, and the current sculptable part obtained through parsing is filled in the UI for display, for example, eyebrows: a sculptable range value ranges from 0 to 50.

A basic face sculpting framework in a form of a plug-in is provided at a technical side. First, a data parsing plug-in is responsible for parsing an art JSON file. The JSON file is parsed into a UI information interface that can be edited by a user. For example, FIG. 12 is a schematic diagram of an interface according to aspects described herein. UI information may be shown in a right box 1201 in FIG. 12.

Aspects described herein provide a plug-in based on an animation blueprint. A face sculpting parameter is configured for calculating an actual skeleton change value.

For example, a value that is obtained through sculpting by the user is configured for continuing location calculation with reference to a current skeleton. A specific algorithm may be: FVector: OneVector+ScaleFactor*Alpha, that is, a current value+a scaling coefficient*an inputted Alpha value.

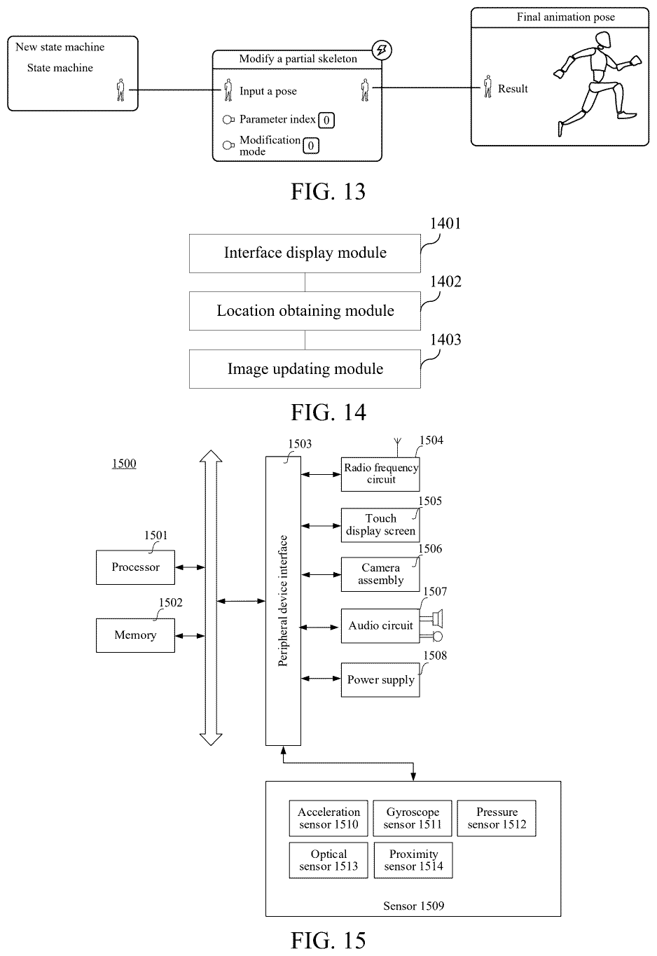

FIG. 13 is a principle diagram of an animation blueprint according to aspects described herein.

Face sculpting (skeleton change) is performed when a character animation is played. An advantage of performing face sculpting in the animation blueprint is that a framework does not need to be modified, and for a plurality of characters sharing the same framework, face sculpting may be performed independently, provided that different face sculpting parameters are inputted to the animation blueprint. In other words, two different characters may share the same face skeleton, and faces may be differentiated through face sculpting.

During running, a player performs a movement operation on a slide bar, and transmits a modified rate value to a face sculpting system. The face sculpting system converts the rate value into coordinate information of a location of the face skeleton. Then the location of the face skeleton is modified by using customized skeleton nodes, to achieve a face sculpting effect.

In the foregoing process, a UE4 engine plug-in generates a customized sculptable range data for face sculpting according to JSON data obtained through parsing. The process may be as follows:

S1: Create an object for face sculpting.

S2: Set a skeleton network (SkeletalMesh) of a character.

S3: Set JSON data that is configured for face sculpting and that is generated by using an art tool.

S4: Obtain various information after setting is completed: a total quantity of face sculpting parameters that are configured, text information specified for each face sculpting parameter, and a maximum/minimum/default value.

S5: Start face sculpting, that is, set a value for each face sculpting parameter: a rate being a ratio value between 0 and 1, and representing setting a face sculpting parameter to a position of the minimum/maximum value specified in the JSON file.

S6: Calculate a numerical result of the face sculpting, and set the numerical result in an animation blueprint system.

Based on the foregoing aspects, a player may customize a face sculpting behavior in a game with a high degree of freedom. Specifically, for example, the player may define attributes of a large quantity of customized characters, define different face areas (an eye area, an eyebrow area, a mouth area, and the like), may display a basic face expression animation, may select different colors, types, materials, and styles corresponding to makeup looks, may store any changed data of a character, may complete (easily adjusts) a visual function interface in a user interface (UI) design tool, and may perform rapid switching between a male and a female.

Face sculpting data may be completed based on a development tool: for example, a digital content creation (DCC) tool, Face sculpting data is not limited by the development tool. Aspects herein provide for simpler face and clearer face sculpting, including during development. Based on the technical solution of performing skin deformation on a skeleton, location transformation is performed on a basic face skeleton, and transformation of a vertex location of a mesh bound to the face skeleton is indirectly driven. Essentially, local transform information of the skeleton is modified.

FIG. 14 is a block diagram of a virtual image configuration apparatus according to aspects described herein. The apparatus includes:
an interface display module 1401, configured to display a virtual image configuration interface, the virtual image configuration interface including a virtual image of a virtual object and a configuration option respectively corresponding to image parameter, and an image parameter that corresponds to each configuration option corresponding to a skeletal part in a skeletal model of the virtual object;
a location obtaining module 1402, configured to determine, in response to a configuration operation from the configuration option, a target configuration option indicated by the configuration operation, and obtain a parameter value of a target image parameter that is in the image parameter and that corresponds to the target configuration option; and determine a target skeletal part corresponding to the target image parameter, adjust a location of the target skeletal part in the skeletal model according to the parameter value of the target image parameter, and obtain adjusted location information of the target skeletal part in the skeletal model; and
an image updating module 1403, configured to update and display the virtual image on the virtual image configuration interface based on the adjusted location information of the target skeletal part in the skeletal model.

For example, the image updating module 1403 is configured to perform skin deformation processing on the skeletal model based on the adjusted location information of the target skeletal part in the skeletal model, to obtain an updated virtual image; and display the updated virtual image on the virtual image configuration interface.

Additionally or alternatively, the interface display module 1401 is configured to obtain a skeleton file and a first description file of the virtual object, the skeleton file including initial skeleton matrix data of the virtual object, and the first description file being configured for indicating the image parameter; display an initial virtual image on the virtual image configuration interface based on the skeleton file; and display, based on the first description file, the configuration option respectively corresponding to the image parameter on the virtual image configuration interface.

For example, the first description file includes an identifier of the image parameter and an adjustment range of the image parameter. The interface display module 1401 is configured to display an option name of a first configuration option on the virtual image configuration interface based on an identifier of a first image parameter, the first image parameter being any one of the image parameter, and the first configuration option being a configuration option corresponding to the first image parameter; and
display an option control of the first configuration option on the virtual image configuration interface based on an adjustment range of the first image parameter.

For example, the location obtaining module 1402 is configured to obtain drive attribute information of the target image parameter, adjust the location of the target skeletal part in the skeletal model based on the parameter value and the drive attribute information of the target image parameter, and obtain the adjusted location information of the target skeletal part in the skeletal model. The drive attribute information of the target image parameter is configured for indicating a changing manner of location information of the target skeletal part when the parameter value of the target image parameter changes.

The drive attribute information of the target image parameter includes: a mapping relationship between the parameter value of the target image parameter and the location information of the target skeletal part.

The apparatus may further include: an obtaining module, configured to obtain a second description file of the virtual object, the second description file including drive attribute information of the image parameter.

For example, the location obtaining module 1402 is configured to obtain the adjusted location information of the target skeletal part in the skeletal model through a plug-in based on an animation blueprint and based on the parameter value of the target image parameter and the drive attribute information of the target image parameter.

The apparatus may further include: an animation generation module, configured to generate a specified animation of the virtual image by using the animation blueprint and based on the adjusted location information of the target skeletal part in the skeletal model; and
an animation display module, configured to display the specified animation of the virtual image on the virtual image configuration interface.

The specified animation is a partial animation corresponding to the target skeletal part. Alternatively, the specified animation is a whole animation corresponding to the skeletal model.

The apparatus may further include: a storage module, configured to store image data of the virtual object, the image data including skeleton matrix data of an updated skeletal model.

Aspects described herein may further provide for division of the foregoing various functional modules in the apparatus. The function distribution may be finished by different functional modules according to actual requirements, that is, a content structure of a device is divided into different functional modules, so as to complete all or some of the functions described above.

Specific manners of performing operations by the modules of the apparatus may be further described herein. Technical effects obtained by performing the operations by the modules are the same as the technical effects provided by aspects described herein.

FIG. 15 is a structural block diagram of a computer device 1500 according to aspects described herein. The computer device 1500 may be a portable mobile terminal, for example, a smartphone, a tablet computer, a moving picture experts group audio layer III (MP3) player, or a moving picture experts group audio layer IV (MP4) player. The computer device 1500 may also be referred as user equipment, a portable terminal, or another name.

Generally, the computer device 1500 includes: a processor 1501 and a memory 1502.

The processor 1501 may include one or more processing cores, for example, a 4-core processor or an 8-core processor. The processor 1501 may be implemented in at least one hardware form of a digital signal processor (DSP), a field programmable gate array (FPGA), and a programmable logic array (PLA).

The memory 1502 may include one or more computer-readable storage media. The computer-readable storage media may be tangible and non-transitory. The memory 1502 may further include a high-speed random access memory, and a non-volatile memory such as one or more magnetic disc storage devices and a flash storage device. A non-transitory computer-readable storage medium in the memory 1502 is configured to store at least one instruction, the at least one instruction being configured to be executed by the processor 1501 to implement the virtual image configuration method according to aspects described herein.

The computer device 1500 may further include: a peripheral device interface 1503 and at least one peripheral device. Specifically, the peripheral device includes: at least one of a radio frequency circuit 1504, a touch display screen 1505, a camera 1506, an audio circuit 1507, and a power supply 1508.

Computer device 1500 further includes one or more sensors 1509. The one or more sensors 1509 include, but are not limited to, an acceleration sensor 1510, a gyroscope sensor 1511, a pressure sensor 1512, an optical sensor 1513, and a proximity sensor 1514.

The computer device 1500 may include more components or fewer components than those shown in the figure, or some components may be combined, or a different component deployment may be used.

A chip is further provided. The chip includes a programmable logic circuit and/or program instructions. When running on a computer device, the chip is configured to implement the virtual image configuration method according to the foregoing aspect.

A computer program product is further provided. The computer program product includes computer instructions. The computer instructions are stored in a computer-readable storage medium. A processor of a computer device reads the computer instructions from the computer-readable storage medium and executes the computer instructions, to implement the virtual image configuration method according to aspects described herein.

A computer-readable storage medium is further provided, the computer-readable storage medium having a computer program stored herein, and the computer program being loaded and executed by a processor to implement the virtual image configuration method according to aspects described herein.

Functions according to aspects described herein may be implemented by hardware, software, firmware, or any combination thereof. When implemented by the software, the functions may be stored in a computer-readable medium or transmitted as one or more instructions or code in the computer-readable medium. The computer-readable medium includes a computer storage medium and a communication medium. The communication medium includes any medium that enables a computer program to be transmitted from one place to another. The storage medium may be any available medium accessible by a general-purpose or dedicated computer.

The foregoing descriptions are merely illustrative of the aspects described herein and are not limiting.

The technical features of the aspects described herein may be combined in any combination. Other possible combinations of the technical features may be applicable to the aspects herein.

Aspects described herein express several illustrative implementations. A person of ordinary skill in the art may make several variations and improvements without departing from the aspects described herein. These variations and improvements shall fall within these aspects.

What is claimed is:

1. A computing method comprising:
causing display of a virtual image configuration interface, the virtual image configuration interface comprising:
a virtual image of a virtual object, and
one or more configuration options, wherein a configuration option corresponds to an image parameter,
one or more image parameters, wherein an image parameter corresponds to a skeletal part in a skeletal model of the virtual object;
receiving, from a configuration operation by a user, a target configuration operation, wherein the target configuration operation comprises:
a target configuration option,
a target image parameter, wherein the target image parameter corresponds to the target configuration option, and
a parameter value of the target image parameter;
determining, based on the target image parameter, a target skeletal part corresponding to the target image parameter;
adjusting, based on the parameter value of the target image parameter, a location of the target skeletal part in the skeletal model;
obtaining adjusted location information of the target skeletal part in the skeletal model; and
on the virtual image configuration interface, causing display of, an updated virtual image based on the adjusted location information.

2. The method according to claim 1, wherein causing display of an updated virtual image further comprises:
performing skin deformation processing on the skeletal model based on the adjusted location information of the target skeletal part in the skeletal model;
obtaining, after performing skin deformation processing, the updated virtual image; and
displaying the updated virtual image on the virtual image configuration interface.

3. The method according to claim 1, wherein causing display of a virtual image configuration interface further comprises:
obtaining a skeleton file and a first description file of the virtual object, wherein the skeleton file comprises initial skeleton matrix data of the virtual object and the first description file is configured for indicating the image parameters;
causing display of an initial virtual image on the virtual image configuration interface based on the skeleton file, wherein the initial virtual image is based on the initial skeleton matrix data; and
causing display of, based on the first description file, the configuration options on the virtual image configuration interface.

4. The method according to claim 3, wherein the first description file comprises, for a first image parameter, an identifier of first image parameter and an adjustment range of the first image parameter, and wherein causing display of the configuration options further comprises:
causing display of an option name of a first configuration option on the virtual image configuration interface, wherein the option name is based on the identifier of the first image parameter, and wherein the first configuration option is a configuration option corresponding to the first image parameter; and
causing display of an option control of the first configuration option on the virtual image configuration interface based on the adjustment range of the first image parameter.

5. The method according to claim 1, wherein adjusting a location of the target skeletal part in the skeletal model further comprises:
obtaining, based on the target image parameter, drive attribute information, wherein the drive attribute information indicates a parameter value of the target image parameter;
adjusting, based on the parameter value, the location of the target skeletal part in the skeletal model.

6. The method according to claim 5, wherein the drive attribute information of the target image parameter comprises:
a mapping relationship between the parameter value of the target image parameter; and
location information of the target skeletal part.

7. The method according to claim 5, further comprising:
obtaining a second description file of the virtual object;
obtaining, from the second description file, drive attribute information.

8. The method according to claim 5, wherein adjusting the location of the target skeletal part in the skeletal model further comprises:
using a plug-in, adjusting the location of the target skeletal part in the skeletal model, wherein the plug-in is based on an animation blueprint.

9. The method according to claim 8, further comprising:
generating, using the animation blueprint and based on the adjusted location information of the target skeletal part in the skeletal model, a specified animation of the virtual image ; and
causing display of the specified animation of the virtual image on the virtual image configuration interface.

10. The method according to claim 9, wherein the specified animation is one of:
a partial animation corresponding to the target skeletal part; or
a whole animation corresponding to the skeletal model.

11. The method according to claim 1, further comprising:
storing image data of the virtual object, wherein the image data comprising skeleton matrix data of an updated skeletal model.

12. A system, comprising:
a processor; and
memory storing computer readable instructions which, when executed, configure the system to perform:
causing, for display, a virtual image configuration interface, the virtual image configuration interface comprising:
a virtual image of a virtual object, and
one or more configuration options, wherein a configuration option corresponds to an image parameter,
one or more image parameters, wherein an image parameter corresponds to a skeletal part in a skeletal model of the virtual object;
receiving, from a configuration operation by a user, a target configuration operation, wherein the target configuration operation comprises:
a target configuration option,
a target image parameter, wherein the target image parameter corresponds to the target configuration option, and
a parameter value of the target image parameter;
determining, based on the target image parameter, a target skeletal part corresponding to the target image parameter;
adjusting, based on the parameter value of the target image parameter, a location of the target skeletal part in the skeletal model;
obtaining adjusted location information of the target skeletal part in the skeletal model; and
on the virtual image configuration interface, causing, for display, an updated virtual image based on the adjusted location information.

13. The system of claim 12, wherein causing display of an updated virtual image further comprises:
performing skin deformation processing on the skeletal model based on the adjusted location information of the target skeletal part in the skeletal model;
obtaining, after performing skin deformation processing, an updated virtual image; and
causing display of the updated virtual image on the virtual image configuration interface.

14. The system of claim 12, wherein causing display of a virtual image configuration interface further comprises:
obtaining a skeleton file and a first description file of the virtual object, wherein the skeleton file comprises initial skeleton matrix data of the virtual object and the first description file is configured for indicating the image parameters;
causing display of an initial virtual image on the virtual image configuration interface based on the skeleton file, wherein the initial virtual image is based on the initial skeleton matrix data; and
causing display of, based on the first description file, the configuration options on the virtual image configuration interface.

15. The system of claim 14, wherein the first description file comprises, for a first image parameter, an identifier of first image parameter and an adjustment range of the first image parameter, and wherein causing display of the configuration options further comprises:
causing display of an option name of a first configuration option on the virtual image configuration interface, wherein the option name is based on the identifier of the first image parameter, and wherein the first configuration option is a configuration option corresponding to the first image parameter; and
causing display of an option control of the first configuration option on the virtual image configuration interface based on the adjustment range of the first image parameter.

16. One or more non-transitory computer readable media comprising computer readable instructions which, when executed, configure a data processing system to perform:
causing, for display, a virtual image configuration interface, the virtual image configuration interface comprising:
a virtual image of a virtual object, and
one or more configuration options, wherein a configuration option corresponds to an image parameter,
one or more image parameters, wherein an image parameter corresponds to a skeletal part in a skeletal model of the virtual object;
receiving, from a configuration operation by a user, a target configuration operation, wherein the target configuration operation comprises:
a target configuration option,
a target image parameter, wherein the target image parameter corresponds to the target configuration option, and
a parameter value of the target image parameter;
determining, based on the target image parameter, a target skeletal part corresponding to the target image parameter; and
adjusting, based on the parameter value of the target image parameter, a location of the target skeletal part in the skeletal model;
obtaining adjusted location information of the target skeletal part in the skeletal model; and
on the virtual image configuration interface, causing, for display, an updated virtual image based on the adjusted location information.

17. The one or more non-transitory computer readable media of claim 16, wherein adjusting a location of the target skeletal part in the skeletal model further comprises:
obtaining, based on the target image parameter, drive attribute information, wherein the drive attribute information indicates a parameter value of the target image parameter;
adjusting, based on the parameter value, the location of the target skeletal part in the skeletal model.

18. The one or more non-transitory computer readable media of claim 17, wherein the drive attribute information of the target image parameter comprises:
a mapping relationship between the parameter value of the target image parameter; and
location information of the target skeletal part.

19. The one or more non-transitory computer readable media of claim 17, wherein adjusting the location of the target skeletal part in the skeletal model further comprises:
using a plug-in, adjusting the location of the target skeletal part in the skeletal model, wherein the plug-in is based on an animation blueprint.

20. The one or more non-transitory computer readable media of claim 19, further comprising:
generating, using the animation blueprint and based on the adjusted location information of the target skeletal part in the skeletal model, a specified animation of the virtual image; and
causing display of the specified animation of the virtual image on the virtual image configuration interface.
